(19) United States
(12) Patent Application Publication
(10) Pub. No.: US 2005/0157499 A1
(43) Pub. Date: Jul. 21, 2005

(54) Interactive image illumination system and method for operating same

(76) Inventor: Eunjoo Kim, San Carlos, CA (US)

Correspondence Address: Peter H. Kang;PMB 814, 751 Laurel St., San Carlos, CA, 94070-3113, US

(21) Appl. No.: 10/346,648

(22) Filed: Jan. 17, 2003

(51) Int. Cl. F21V 33/00

(52) U.S. Cl. 362/293

(57) ABSTRACT

An illuminated interactive entertainment system includes an illumination source, a transparent slide holder comprising slots, and slides adapted to be inserted into said slots, whereby images on said slides may be projected onto a suitable surface and interacted with by a user. Slides with handles are further provided, in one embodiment, to allow user interaction with said images. In another aspect, the slide holder may be angled to provide an illuminated drawing surface, to allow a user to interact with images by drawing on them. Slides with images or text may be provided, especially for educational, artistic, or entertainment uses of the illumination system for children.

### BACKGROUND

This invention relates generally to an interactive image illumination system, and a method for operating an illuminated image system interactively. The technical field of the invention relates generally to systems for illuminating transparent or translucent slides whereby images may be created, projected, and interacted with for entertainment, educational, business, or artistic purposes of people, including children.

It is known in the art to provide a slide projector to project images on a suitable surface, such as a screen or a blank wall. Images projected by a slide projector are typically static reproductions of photographs or artistic works. Slides used with slide projectors cannot typically be edited, drawn on, or interacted with by a viewer while being projected.

It is also known in the art to provide an overhead projector to project images or text which may be edited interactively by a user. Overhead projectors are known in the art, and typically comprise a flat transparent projection surface on which transparencies or slides comprising images or text are laid, a light source underneath the projection surface, and a mirror and lens assembly to focus and project the image or text onto a suitable surface. Overhead projectors typically utilize incandescent light bulbs mounted in an enclosed structure, which results in generation of an undesirable amount of heat, thus requiring in such systems a cooling fan housed beneath the projection surface. The use of a flat projection surface on which transparency slides may be placed and written on limits users' abilities to overlay multiple images from multiple slides, causes transparencies to become hot after prolonged exposure thus limiting usefulness for children, requires users to coordinate viewing of both the flat projection surface and the projected image, creates visual discomfort caused from a user having to look directly or substantially directly at the light source when writing or drawing on the slide, and limits entertaining or interactive operation of an overhead projector.

Accordingly, conventional projection and slide illumination systems provide limited configurations for interacting with the images being projected. Therefore, a need has arisen for an illumination system that addresses the disadvantages and deficiencies of the prior art. In particular, a need has arisen for an illumination system which allows improved interactivity and operational facilities for entertainment, artistic, and educational development of people, including children.

### SUMMARY

An advantage of one aspect of one embodiment of the present invention is to provide a system which allows a user to interact with the images illuminated or projected by the system.

Another advantage of one aspect of one embodiment of the present invention is to provide an illuminated system whereby a user may edit, draw on, or otherwise add to images illuminated by said system.

Accordingly, in accordance with one aspect of one embodiment of the invention an illuminated interactive entertainment system is disclosed. In this aspect, the illuminated interactive entertainment system includes a casing, a light source, and a slide holder comprising a plurality of slots.

In a further aspect, the system includes transparent or translucent slides which may be inserted into the slots in the slide holder, said slides comprising images or text, whereby the light source illuminates images or text on said slides and projects the images or text on a suitable surface.

In another aspect, the system comprises an illumination source, an adjustable slide holder, a translucent slide inserted into slots in the slide holder, and a support for the slide holder, whereby the slide holder may be adjusted by angling the slide holder to provide a surface on which on user may draw or otherwise interact with images on the slide.

In yet another aspect, a method in accordance with one aspect of one embodiment of the invention includes providing an illumination source, providing a slide holder, inserting slides into slots in the slide holder, interacting with the slides, whereby images on the slides are projected onto a suitable surface.

In a further aspect, a method comprises providing slides comprising handles, whereby users may interact with the images projected by manipulating the handles for the slides.

In another aspect, a method in accordance with one embodiment of the invention includes providing an illumination source, providing an adjustable slide holder comprising a support and slots for holding slides, inserting a rigid and opaque or translucent slide into one of the slots, inserting a slide into a second of the slots, adjusting the slide holder to lean on the support and provide an angled surface, and interacting with the slides.

In a further aspect, a method further comprises drawing on the second slide or otherwise interacting with the first and second slides, for example with handles provided for third slides which may be inserted into apertures formed at the bottoms of the slide slots.

These and other aspects of various embodiments of the present invention are better understood upon consideration of the description below and the accompanying drawings.

### BRIEF DESCRIPTION OF THE DRAWINGS

For a more complete understanding of aspects of various embodiments of the present invention and for further features and advantages, reference is made to the following description in conjunction with the accompanying drawings, in which:

FIG. 1 is a side view of an illuminated interactive system, in the closed position, in accordance with an aspect of the present invention.

FIG. 2 is a side view of an illuminated interactive system, in the open position, in accordance with an aspect of the present invention.

FIG. 3 is a perspective view of an illumination source assembly and a portion of an illuminated interactive system in accordance with an aspect of the present invention.

FIG. 3A is a side view of an illumination source assembly in accordance with an aspect of the present invention.

FIG. 3B is a side view of an illumination source assembly in accordance with a further aspect of the present invention.

FIG. 3C is a circuit diagrammatic view of electronic and electrical features of an illumination assembly in accordance with an aspect of the present invention.

FIG. 4 is a perspective view of a slide holder assembly and a portion of an illuminated interactive system in accordance with an aspect of the present invention.

FIG. 4A is a perspective view of a slide holder assembly in accordance with an aspect of the present invention.

FIG. 4B is an exploded perspective view of a slide holder assembly in accordance with an aspect of the present invention.

FIGS. 5A through 5D in FIG. 5 are various slides which are adapted to be used with an illuminated interactive system in accordance with aspects of the present invention.

FIG. 6 is a side view of operation of an illuminated interactive system in accordance with an aspect of the present invention.

FIG. 7 is a side view of operation of an illuminated interactive system in accordance with yet a further aspect of the present invention.

FIG. 8 is a side view of an illuminated interactive system in accordance with a further aspect of the present invention.

FIGS. 9A to 9C are each a side view of an illuminated interactive system in accordance with a further aspect of the present invention.

In the present disclosure, like and corresponding parts or objects which appear in the various drawings are provided with like reference numerals.

### DETAILED DESCRIPTION Various aspects of the embodiments of the present invention and their advantages can be appreciated by referring to the figures and the description herein.

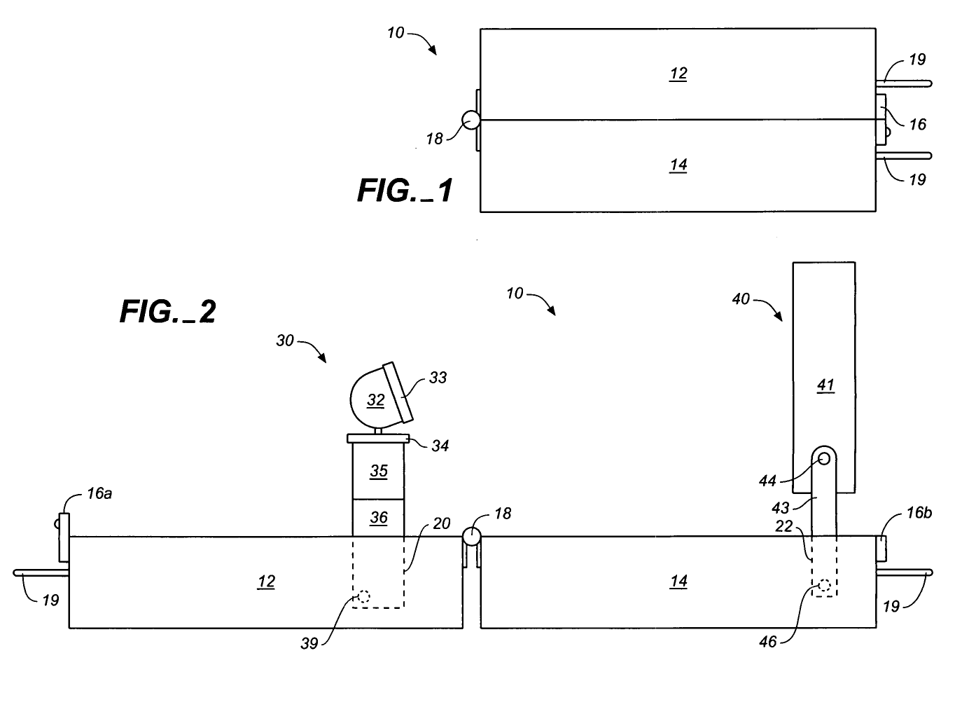

Referring to FIG. 1, an illuminated interactive system 10 is shown. In FIG. 1, illuminated interactive system 10 includes a top portion casing 12 and bottom portion casing 14. Top portion casing 12 and bottom portion casing 14 may, in one embodiment, be formed of wood. Top portion casing 12 is rotatably connected to bottom portion casing 14 by hinge assembly 18. Hinge assembly 18 is any suitable hinge, and in one embodiment is a recessed hinge. Hinge assembly 18 may be formed of brass or any suitable material.

Illuminated interactive system 10 is shown in FIG. 1 in the closed position, where top portion casing 12 and bottom portion casing 14 form a protective box or clamshell which provides suitable carrying and protective features for interactive system 10.

Top portion casing 12 may be fastened in the closed position with bottom portion casing 14 by fastener 16. Fastener 16 may be any suitable catch or locking mechanism. By locking or fastening fastener 16, interactive system 10 is more readily portable. Fastener 16 may be formed of brass, or other suitable material.

Interactive system 10 may include carrying handle 19. Carrying handle 19 may be formed of leather, wood, or any suitable material.

It will be appreciated that when interactive system 10 is in the closed position as shown in FIG. 1, system 10 is portable, the interior features of system 10 are protected from external elements or inadvertent damage, and system 10 thus may be formed to resemble a conventional briefcase, artist's box, or similar portable luggage. Those of ordinary skill will appreciate that decorative elements or formation of top casing portion 12 and bottom casing portion 14 may allow system 10 to resemble any desired portable apparatus which has a clamshell exterior casing, such as a laptop computer.

Referring to FIG. 2, an illuminated interactive system 10 is shown in the open position. The internal elements of interactive system 10 are revealed when system 10 is in the open position.

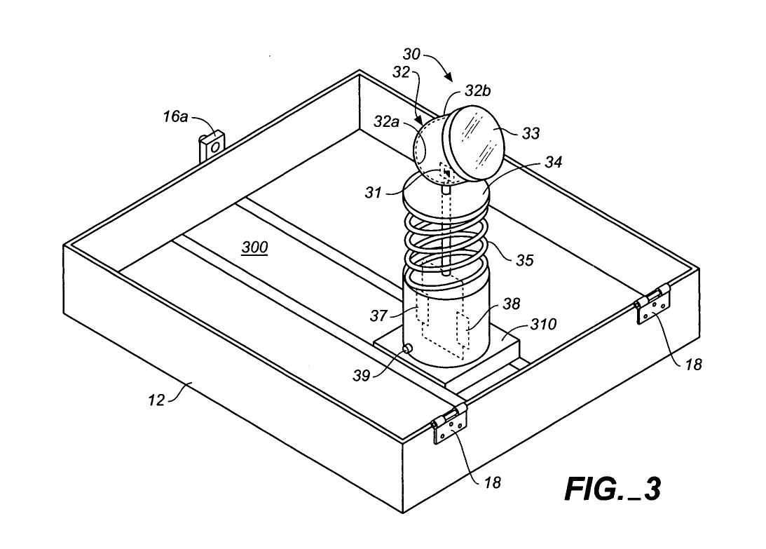

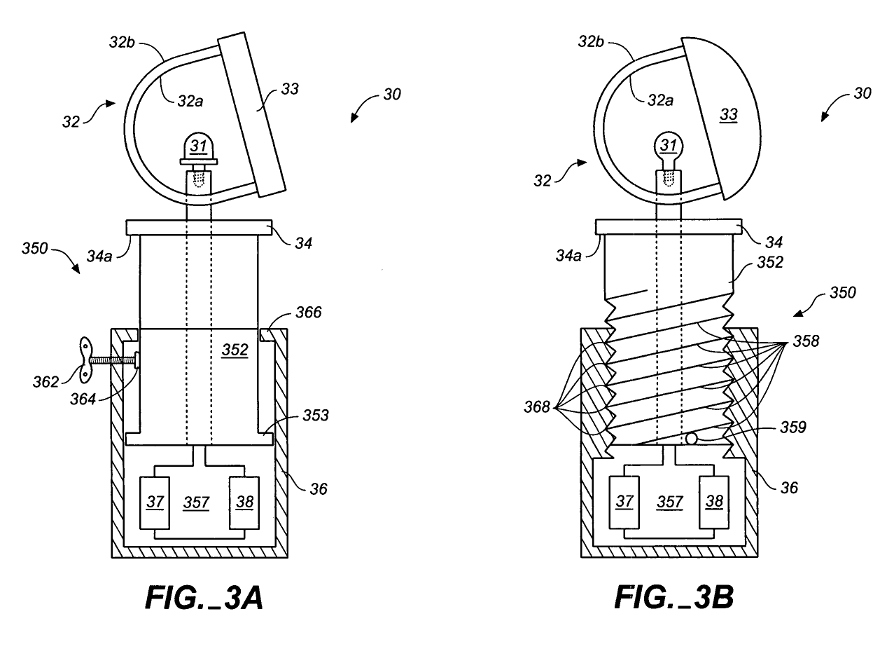

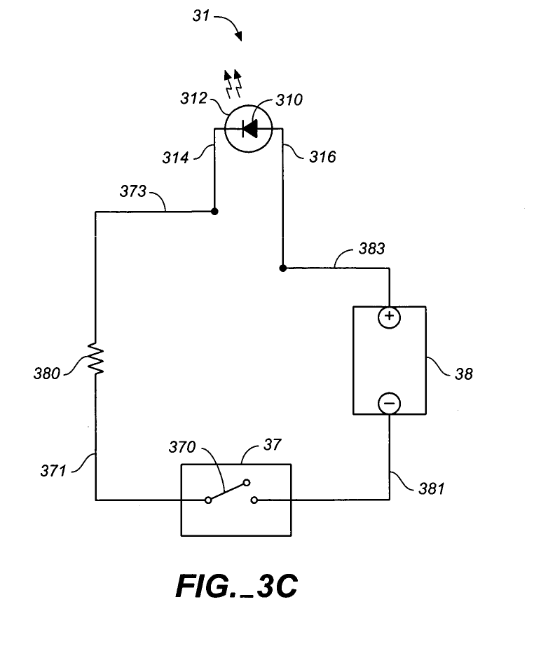

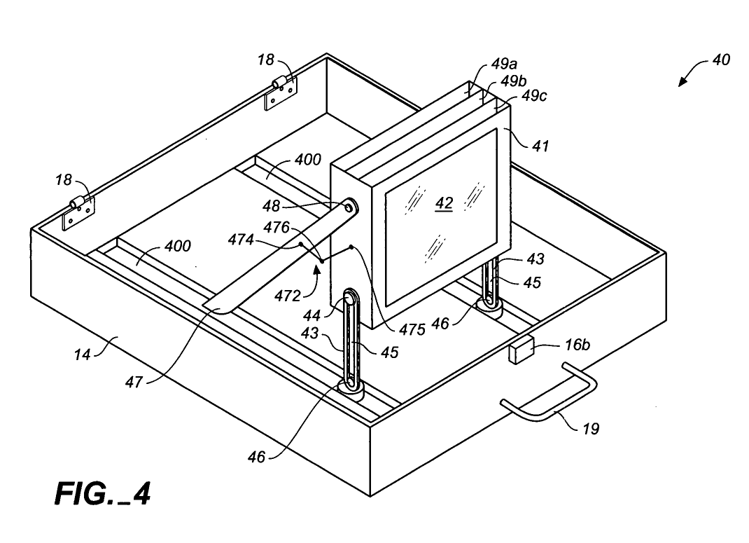

Illumination source assembly 30 is shown connected to top casing portion 12. Illumination source assembly 30 is a rotatable, vertically movable light source which provides illumination for system 10. Illumination source assembly 30 is rotatably mounted to the interior of top casing portion 12 by hinge assembly 20. In one embodiment, illumination source assembly 30 has a width equal to or less than the depth of the interior of top casing portion 12. In this manner, when a user desires to place illuminated interactive system 10 in the closed position, illumination assembly 30 may be rotated about hinge 20 so as to rest flush within the cavity defined by the interior of top casing portion 12. Various other detailed aspects of embodiments of illumination source assembly 30 are described further in connection with FIG. 3 below.

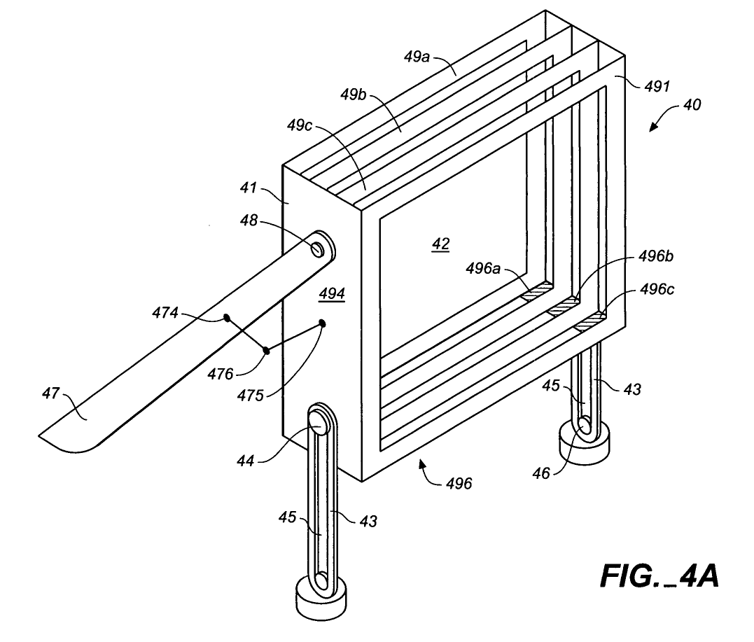

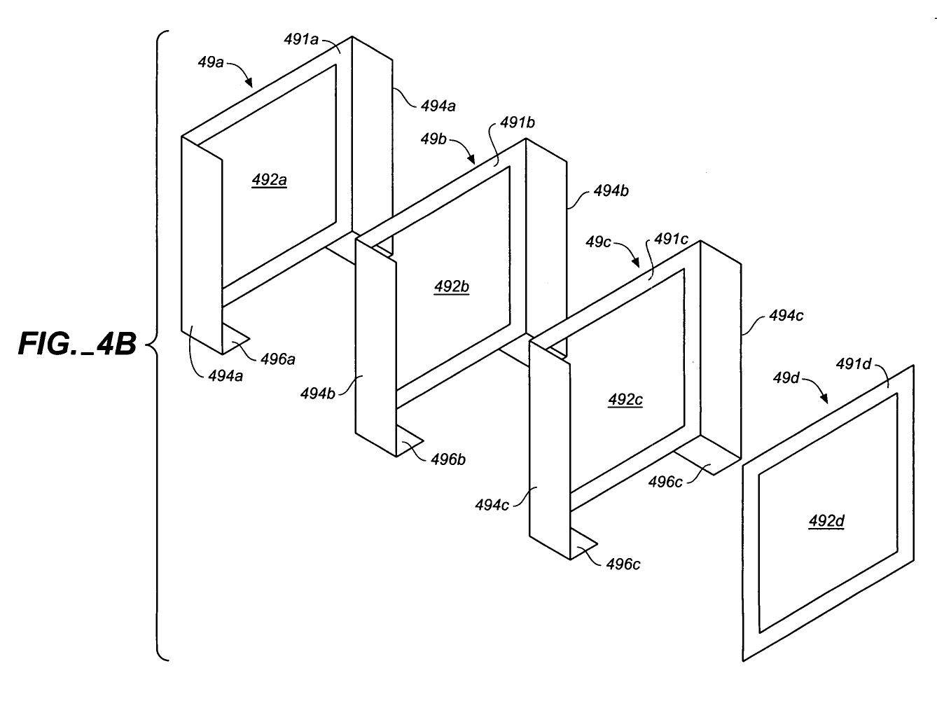

In FIG. 2, slide holder 40 is shown connected to bottom casing portion 14. Slide holder 40 is formed of wood and is rotatably connected to the interior of bottom casing portion 14 by hinge 22. Slide holder 40 receives light from illumination source 30, and provides some structure by which a user may interact with system 10. In one embodiment, slide holder 40 has a width equal to or less than the depth of the interior of bottom casing portion 14. In this manner, when a user desires to place illuminated interactive system 10 in the closed position, slide holder 40 may be rotated about hinge 22 so as to rest flush within the cavity defined by the interior of bottom casing portion 14. Various other detailed aspects of embodiments of slide holder 40 are described further in connection with FIG. 4 below.

In FIG. 2, when system 10 is in the open position, fastener 16 may, in one embodiment, include top fastener portion 16a and bottom fastener portion 16b. Top fastener portion 16a is mounted on top casing portion 12 by conventional means, including nail, screw, glue, or any combination thereof. Similarly, bottom fastener portion 16b is mounted on bottom casing portion 14 by conventional means.

In FIG. 2, hinge assembly 18 is shown between the top casing portion 12 and bottom casing portion 14. In one embodiment, hinge assembly 18 may be recessed to allow top casing portion 12 and bottom casing portion 14 to rest flush against each other when system 10 is in the open position. In an alternate embodiment, hinge assembly 18 may be mounted on the interior surfaces of top casing portion 12 and bottom casing portion 14, so as to be not easily visible when system 10 is in the closed position, but readily visible when system 10 is in the open position.

Referring to FIG. 3, an illumination source assembly 30 is shown in connection with top casing portion 12 of an illuminated interactive system 10.

Illumination source assembly 30 includes light bulb 31. Light bulb 31 may be, in one embodiment, a white LED (light emitting diode). In this embodiment, light bulb 31 provides illumination without generating an amount of heat higher than a desired predetermined threshold. For example, governmental or industry safety regulations or guidelines for children's toys may proscribe limits on the amount of heat which a light bulb 31 can shed.

In other embodiments, light bulb 31 may be a fluorescent lightbulb, an incandescent lightbulb, or any other desired colored LED (including but not limited to red, green, or blue).

Light bulb 31 is mounted inside housing 32. Housing 32 is, in one embodiment, a semi-spheroid with an interior surface 32A which, in one embodiment, is reflective. Interior surface 32A of housing 32 may be coated with a reflective material, may be metal, or may be any conventional reflective surface. By providing reflective properties, interior surface 32A of housing 32 enhances the illumination provided by lightbulb 31.

In other embodiments, interior surface 32A may be any other desired color (including white, off-white, or yellow) and may be a non-smooth surface (including faceted, coated with glitter, or pitted).

Illumination source assembly 30 includes lens 33. Lens 33 may be any conventional lens. In one embodiment, lens 33 is formed of a circular piece of glass which is inserted into a receiving notch in the interior surface 32A of housing 32. In other embodiments, lens 33 may be formed of any suitable material (including transparent or translucent plastic), may be any desired color or tint, may be concave or convex, and may be grooved or otherwise shaped. In system 10, lens 33 focuses light emanating from light bulb 33 towards slide holder 40.

In another embodiment, lens 33 comprises an adjustable magnifying lens with focusing controls. In this embodiment, illumination source assembly 30 may comprise a mag-light or focusable light. In this embodiment, a user may control focus, brightness, and spread of light emanating from illumination source assembly 30. In this way, a user may interact with an image on slide holder 40 by controlling specific features associated with illumination of the image, such as focus, brightness, and other luminescence features.

Housing 32 in FIG. 2 is rotatably mounted on swivel platform 34. Swivel platform 34 provides a base on which housing 32 may rest. Swivel platform 34 allow housing 32 to be rotated by a user in any desired direction. Housing 32 is connected to swivel 34 by, for example, a ball and socket joint, a rotating screw head, or any conventional attachment which allows housing 32 to rotate about at least one axis. Swivel 34 allows a user to direct illumination from light bulb 31 in any desired direction, preferably towards slide holder assembly 40 or any desired portion thereof.

In FIG. 2, swivel platform 34 is connected to height adjuster 35. Swivel 34 is connected to height adjuster 35 by screws, crimp connectors, nut and bolt, or any conventional attachment which fixedly connects swivel platform 34 to height adjuster 35. In one embodiment, height adjuster 35 comprises a rigid spring assembly formed of metal or composite or other appropriate material. In this embodiment, height adjuster 35 is sufficiently rigid to support the weight of lightbulb 31, housing 32, lens 33, and swivel 34, without deforming. In this embodiment, height adjuster 35 may be manipulated by a user of system 10 to adjust the height of housing 32 and thus the height at which light bulb 31 may be directed at slide holder 41. In this embodiment, height adjuster 35 is formed with sufficient rigidity and tensile strength to allow users to deform the shape or height of the spring comprising height adjuster 35, such that when a user manipulates height adjuster 35 to return to its original position, the material of height adjuster 35 resumes its original shape and configuration. In one embodiment, wiring which electrically connects light bulb 31 to control circuit 37 and power source 38 may be arranged coaxially with the windings of the spring comprising height adjuster 35. In other embodiments, the wiring which electrically connects light bulb 31 to control circuit 37 and power source 38 is vertically drawn within the lumen defined by the windings of the spring comprising height adjuster 35.

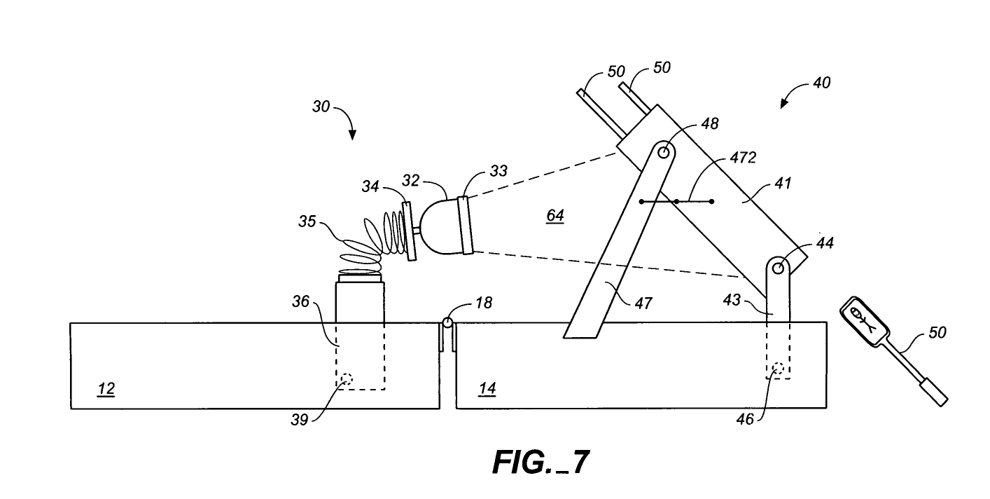

In other aspects, height adjuster 35 may be formed of sufficiently rigid material to allow housing 32 to be manipulated by a user not only in the vertical plane but also horizontally. In this embodiment, height adjuster 35 comprises a spring of sufficiently rigid and tensile material, such as a suitable metal, to support the weight of light bulb 31, housing 32, lens 33, and platform 34 when height adjuster 35 is stretched by a user both vertically and horizontally. In this way, for example, a user may control the height of the illumination provided by light bulb 31 and the distance of light bulb 31 from a desired target such as slide holder 40. As discussed further below with respect to FIG. 7, operation of height adjuster 35 allows adjustment by a user of system 10 of the intensity and focus of illumination to be provided to an image.

The bottom portion of height adjuster 35 is fixedly connected to base casing 36, as shown in FIG. 2. In one embodiment, base casing 36 is a tubular structure formed from metal or other appropriate material. Base casing 36 has a lumen formed within, and holds control circuitry 37 and power source 38 within the lumen of base 36. Those of ordinary skill will appreciate that the shape, height, and diameter of base casing 36 can be varied without departing from the scope of the invention.

In an alternate embodiment, height adjuster 35 comprises a telescoping casing 350, such as shown in FIG. 3A. Telescoping casing 350 is a conventional tubular casing formed of two portions, movable casing 352 and base casing 36. Movable casing 352 is a tube. The upper end of movable casing 352 is in active contact with the underside 34a of swivel platform 34, such that when movable casing 352 moves in a vertical direction, swivel platform 34, and thus housing 32 containing light bulb 31, will also move a corresponding distance in a vertical direction. This vertical movement of movable casing 352 can be effected by the user in an amount desired.

Base casing 36 in this embodiment is a tubular structure with a lumen within which are placed control circuitry 37 and power source 38. The bottom end of movable casing 352 sits within the lumen formed by base casing 36, such that movable casing 352 is co-axial with base or bottom casing 36. The maximum diameter of the movable casing 352 is smaller than the diameter of the lumen of base casing 36, and in one embodiment movable casing 352 has a diameter less than 1 centimeter smaller than the diameter of the lumen of base casing 36. In this way, movable casing 352 can be interacted with by a user to adjust the height of illumination assembly 30 as desired, by sliding or telescoping movable casing in a vertical direction within the lumen of base casing 36.

In one embodiment, movable casing 352 may be held in place by friction screw 362. Friction screw 362 is mounted horizontally through a hole in base casing 36, such that the head of friction screw 362 is outside base casing 36 and the distal end of friction screw 362 can be made to impact the exterior surface of movable casing 352. Friction screw 362 can be loosened in order to allow movable casing to be moved as desired, and friction screw 362 can be tightened so that the distal end of friction screw 362 imparts sufficient frictional force on the exterior of movable casing 352 such that movable casing 352 is held at a desired height. In one embodiment, friction screw 352 may further comprise a friction plate 364 mounted at the distal end of friction screw 362, to allow a larger surface area of friction screw 362 to impact movable casing 352.

As shown in FIG. 3B, in an alternate embodiment, the upper rim of base casing 36 can include an overhang 366. In this embodiment, the maximum external diameter of movable casing 352 is smaller than the diameter of the lumen formed by overhang 366. In this embodiment, movable casing 352 includes flare 353 at the bottom end of movable casing 352. The maximum diameter of flare 353 is larger than the diameter of movable casing 352, but less than the diameter of the lumen 357 of base casing 36. Flare 353 also has a diameter larger than the diameter of the lumen formed by overhang 366. With this arrangement, flare 353 will impact overhang 366 when movable casing 352 is moved upward. The blocking effect of overhang 366 will restrict movement of movable casing 353 beyond a point where movable casing 353 could be removed entirely from the lumen 357 of base casing 36. The interaction of overhang 366 and flare 353 thus helps to keep illumination assembly 30 from being taken apart inadvertently. Those of ordinary skill will appreciate that the precise shapes of overhang 366 and flare 353 can be any desired shape, for example rounded or angled, for ease of assembly during the manufacturing process.

As shown in FIG. 3B, in an alternate embodiment, the external surface of the bottom portion of movable casing 352 can include male screw turns 358. In this embodiment, base casing 36 can include female screw turns 368 formed in the internal surface of a corresponding area of the upper portion of base casing 36. These female screw turns 368 thus face inward towards lumen 357 of base casing 36. In this embodiment, movable casing 352 is rotatably mounted onto base casing 36 by mating male screw turns 358 with corresponding female screw turns 368. It will be appreciated by those of ordinary skill that the precise radius of male screw turns 358 and female screw turns 368, as well as the number of each provided, can be varied for any desired configuration of illumination assembly 30 and these factors are not limitations of the scope of the invention, as long as male screw turns 358 are formed so as to fit into female screw turns 368.

In an alternate embodiment, in FIG. 3B a stopper 359 can be provided at the base of movable casing 352 to engage with a corresponding stopper 359 (not shown) provided on the interior surface of base casing 36 at or near the top of base casing 36. Stopper 359 can stop movable casing 352 from being unscrewed completely from base casing 36, by engaging the corresponding stopper 359 of base casing 36. Those of ordinary skill will appreciate that there are many alternate structures to prevent a screw from completely unscrewing from a female member, and any appropriate such structure may be implemented without departing from the scope of the invention.

Referring to FIG. 3C, electronic and electrical features of illumination assembly 30 are shown. Control circuitry 37 and power source 38 are mounted within lumen 357 of base casing 36 by conventional means. Control circuitry 37 includes on/off switch 370. On/off switch 370 is a user-manipulable switch, which can be formed of insulated metal, plastic and metal sub-components, or other appropriate materials. Those of ordinary skill will understand that there are many types of switches 370 which can be incorporated into a system 10 without departing from the scope of the invention, including slide switches, push buttons, turn switches, or pressure contact switches.

In an alternate embodiment, control circuitry 37 may include a dimmer circuit; an infrared signal receptor and conventional circuitry to allow on/off switch 37 to be controlled by an infrared remote control device; timer circuitry to allow user control over pulsing of illumination source assembly 301; and other appropriate circuitry for a user to interact with system 10, including processors, memory, I/O devices, data ports, wireless transmitter/receiver, digital display, audio player, or other information handling system components.

Power source 38 comprises an appropriate source of energy to provide the energy necessary to cause light bulb 31 to illuminate effectively. Depending on the type of light bulb 31 and other electrical characteristics desired, power source 38 will be implemented to be the appropriate driver for light bulb 31. Power source 38 comprises, in one embodiment, a battery. Those of ordinary skill will understand that many types of batteries can be incorporated into a system 10 without departing from the scope of the invention, including lithium batteries, dry cell batteries, standard batteries, rechargeable batteries, solar batteries, ion batteries, coin batteries, and any desired combination of batteries. In one embodiment, power source 38 comprises a plurality of AA cell batteries. In other embodiments, power source 38 comprises circuitry to connect system 10 to an external AC or DC power source. In this embodiment, casing 12 of system 10 will have outlet jacks, connection ports, or other suitable apertures through which to electrically or electronically connect power source 10 to cables or other appropriate connectors (direct and indirect) to an external power source. In this embodiment, power source 38 may include a transformer, and in alternate embodiments, the transformer may be included with the external connections to the AC or DC source. Those of ordinary skill will appreciate that in those embodiments where power source 10 comprises a rechargeable battery or a solar battery, casing 12 of system 10 will also have appropriate apertures, jacks, or outlets provided to connect power source 38 to external connectors, power sources, solar cells, or other appropriate external circuitry, transformers, cables, wires, or connections direct and indirect to furnish power source 38 with an active amount of power.

Referring to FIG. 3C, power source 38 is connected via conductive element 381 to control circuitry 37. Control circuitry 37 is, in turn, connected to resistive element 380 via conductive element 371. Resistive element 380 is a conventional resistor circuit element. Resistive element 380 should be selected with the appropriate ohmic properties to condition the electrical properties of the signal passed via conductors 381, 371, and ultimately 373 and 383 to provide power with the proper electrical characteristics for light bulb 31.

Those of ordinary skill will appreciate that for embodiments where light bulb 31 is an LED, the proper resistance value for resistive element 38 can be determined by straightforward application of Ohm's law. In one embodiment, where light bulb 31 is one or more LEDs having an operating voltage Vₒ and an operating current of Iₒ (measured in milliamps, mA), and where power source 38 provides a source voltage Vₛ, then the resistance value R of resistive element 380 can be calculated using the following equation:
R=[(Vₛ)−(Vₒ)]/[(Iₒ)*1,000]

Those of ordinary skill will appreciate that resistive element 380, in this embodiment, need not have precisely the resistance value so calculated, and may have a value approximating this calculated value within a reasonable degree of tolerance appropriate for the LED or other illumination source used for light bulb 31.

Referring to FIG. 3C, the output of resistive element 380 is electrically communicated to light bulb 31 via conductor 373. Light bulb 31 is, then, in turn connected to power source 383 via conductor 383, thus completing the circuit.

In one embodiment, conductor 373 is electrically connected to the cathode 314 of light bulb 31, thus connecting the output of resistive element 380 to cathode 314. In this embodiment, conductor 383 is electrically connected to the anode 316 of light bulb 31, thereby connecting the output of light bulb 31 to one terminal of power source 38.

As noted above, light bulb 31 may be, in one embodiment, a white light emitting diode (LED). In one embodiment, light bulb 31 may be a rectangular surface mount white LED (such as model number NSCW100) commercially available from Nichia America, Inc. In other embodiments, light bulb 31 may be implemented as one or more (up to any desired number) of discrete white LEDs, having an operating voltage of approximately 3.6 to approximately 4.0 V, an operating current of approximately 20 mA to approximately 30 ma, a luminous intensity of approximately 320 mcd to approximately 380 mcd, a half angle directivity of approximately 20 degrees to approximately 60 degrees, a power dissipation of approximately 100 mW to approximately 120 mW, and with a resulting chromaticity of approximately 310x by 320y on the CIE chromaticity chart, with a color temperature ranging anywhere from approximately 5,500° K. to approximately 8,000° K., and with a color rendering index of approximately 85 or higher. In these embodiments, light bulb 31 may be any suitable light bulb to create illumination which appears substantially or wholly white to the human eye.

Referring to FIG. 3C, light bulb 31 will, in this embodiment, include an active light emitting element 310 having an anode and a cathode, which as noted are electrically connected to conductors 373 and 383 by conventional means. Light bulb 31 also includes diffusor 312, which, in one embodiment is clear solid resin. In other embodiments, diffusor 312 may include a reflector base above which active light emitting element 310 may be situated. In other embodiments, this reflector base may be incorporated in or connected to light emitting element 310.

Those of ordinary skill will appreciate that light bulb 31 may be any desired light bulb without departing from the scope of the invention. For example, in other embodiments, light bulb 31 may be a blue LED, green LED, red LED, yellow LED, a combination of colored LEDs configured to jointly produce a white light, an incandescent light bulb, a neon light bulb, a halogen light bulb, a fluorescent light bulb or tube, a cold-cathode fluorescent lamp, a conventional lamp, or a plurality of any desired combination of light bulbs. In other embodiments, diffusor 312 may be tinted resin, a phosphor, clear glass, tinted glass of any desired color, a combination filter and lens, plastic (clear or tinted), or any suitable composite.

Operation of the circuitry of FIG. 3C is as follows. When control circuitry 37 is operated so as to put on/off switch 370 in the “on” state or condition, the electrical circuit is established allowing the output of power source 38 to be electrically communicated via conductors 381, 371, and 373 to light bulb 31, thus energizing light bulb 31 and allowing the light bulb to output light through lens 33. When control circuitry 37 is placed in condition so that on/off switch 370 is in the “off” state or condition, the electrical circuit is broken, and power source 38 is electrically decoupled from light bulb 31, thus resulting in no illumination to emanate from light bulb 31. Those of ordinary skill will appreciate that conductive elements 381, 371, 373, and 383 may be formed of any appropriate conductor, including insulated wire. Those of ordinary skill will understand that, in some embodiments, resistor 380 is unneeded, and that in other embodiments, resistor 380 may be incorporated into the structures of light bulb 31, into control circuitry 37, or into power source 38.

Referring to FIG. 2, base casing 36 is connected to pivot hinge 39. Pivot hinge 39 connects base casing 36 to the interior surface of system casing 12. Pivot hinge also provides a pivot on which illumination assembly 30 may turn, so as to allow illumination assembly 30 to lie flat within the interior of system casing 12 when the system is in the closed position.

In one embodiment, pivot hinge 39 connects base casing 36 of illumination assembly 30 to sliding platform 310. Sliding platform 310, in turn, sits within groove 300 which is formed within the interior surface of system casing 12. Groove 300 has lips which hold sliding platform 310 from being lifted out of groove 300, and sliding platform 310 can be operated to move laterally along the axis of groove 300 any desired distance. A user may, in this embodiment, move sliding platform 310 and thus the entire illumination assembly 30 any desired distance backwards or forwards, closer or nearer to slide holder 40. Movement of illumination assembly 30 along the axis of groove 300 allows a user to control brightness of image, focus image clarity, and interact with and control the presentation of the image to be shown from slide holder 40. In another embodiment, groove 300 may be fashioned to have a section without retaining lips, to allow a user to remove illumination assembly 30 entirely from system 10 if desired or to allow a user to substitute an alternate illumination assembly 30 into system 10. In an alternate embodiment, groove 300 may be formed in the interior surface of both system casing 12 and system casing 14. In this embodiment, illumination assembly 30 may be moved from casing 12 and inserted into the continuation of groove 300 in casing 14, thus allowing a user to place illumination assembly 30 as close as desired to slide holder 40.

Referring to FIG. 4, a slide holder assembly 40 is shown in connection with a portion of an illuminated interactive system 10. Slide holder assembly 40 comprises frame 41. Frame 41 is a rectangular box like frame which surrounds a blank viewing area 42. In one embodiment, frame 41 is formed of wood and is approximately 12 inches long by 8 inches tall at its outer periphery, and approximately 3 inches deep. Viewing area 42 is approximately 10 inches long by 6 inches tall by 3 inches deep.

Frame 41 is supported by two adjustable legs 43 which are connected to the side panel 494 of frame 41 by lockscrew 44. Referring to FIG. 4A, each adjustable leg 43 has a slit 45 formed within the leg 43's major axis. One lockscrew 44 is fixedly mounted each side panel 494 of frame 41. In one embodiment, lockscrew 44 is mounted at the center point of wall panel 494. Those of ordinary skill will understand that the precise location of lock screw 44 is not a limitation of the invention. The shaft of lockscrew 44 is orthogonal to the plane of wall panel 494 of frame 41. The shaft of lockscrew 44 is threaded through slit 45 of leg 43. Locking nut 442 is threaded on the shaft of lockscrew 44 so that leg 43 is between locking nut 442 and wall panel 494. By loosening locking nut 442 on lockscrew 44, a user may adjust the height of slide holder assembly 40 by moving it to a desired height, and then by tightening locking nut 442 on lockscrew 44, a user thus causes locking nut 442 to frictionally compress leg 43 between locking nut 442 and wall panel 494 and thus maintain slide holder assembly 40 at a desired height. Those of ordinary skill will appreciate that there are many ways to provide adjustable height legs using different mechanical apparatus, such as sliding interlocked legs, telescoping legs, collapsible legs, other arrangements of nuts and screws, and other conventional adjustable supports, and the invention is not limited by the type of height adjustment provided. In an alternate embodiment, legs 43 are not height adjustable. In another embodiment, a single leg 43 is provided to support frame 41 and is connected to the center bottom portion of frame 41.

Each leg 43 is rotatably connected at the bottom to slide holder pivot base 46. Pivot base 46 connects each leg 43 to the interior surface of system casing 14. Pivot base also provides a pivot on which slide holder assembly 40 may turn, so as to allow slide holder assembly 40 to lie flat within the interior of system casing 14 when the system is in the closed position (as shown in FIG. 1).

In one embodiment, pivot base 46 comprises a screw with a locking nut. Those of ordinary skill will understand that there are many ways to rotatably connect leg 43 to pivot base 46 (such as by providing a hinge formed at the base of each leg which is fixedly attached to pivot base 46, or providing an axle mounted within casing 14 and rotatably mounting legs 43 on this axle) and the invention is not limited by the specific implementation of this rotatable connection. In another embodiment, each pivot base 46 may sit within a groove 400 which is formed within the interior surface of system casing 14. Groove 400 has lips which hold pivot base 46 from being lifted out of groove 400, and pivot base 46 can be operated to move laterally along the axis of groove 400 any desired distance. A user may, in this embodiment, move pivot base 46 and thus the entire slide holder assembly 40 any desired distance backwards or forwards, closer or nearer to illumination assembly 30. Providing adjustment of slide holder assembly 40 along the axis of groove 400 allows a user to control brightness of image, focus image clarity, and interact with and control the presentation of the image to be shown from slide holder 40. In another embodiment, groove 400 may be fashioned to have a section without retaining lips, to allow a user to remove slide holder assembly 40 entirely from system 10 if desired or to allow a user to substitute an alternate slide holder assembly 40 into system 10. In an alternate embodiment, grooves 400 may be formed in the interior surface of both system casing 12 and system casing 14. In this embodiment, slide holder assembly 40 may be moved from casing 14 and inserted into the continuation of grooves 400 in casing 12, thus allowing a user to place slide holder assembly 40 as close as desired to illumination assembly 30. In an embodiment where casing 12 and casing 14 have both grooves 300 and 400, a user may thus interchange or flip the locations of slide holder assembly 40 and illumination assembly 30 from their respective casings 12 and 14, if desired.

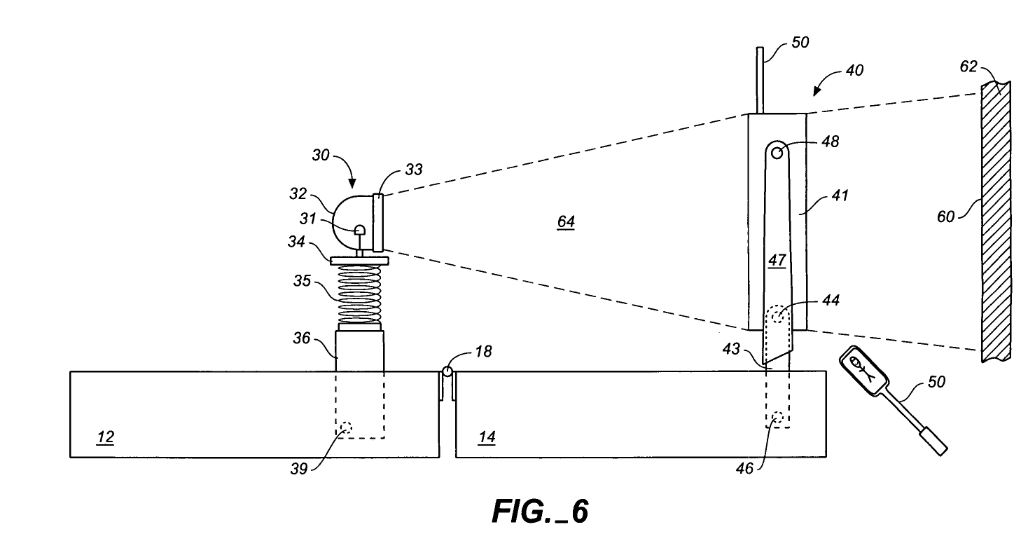

Referring to FIG. 4, leg 47 is rotatably connected to wall panel 494 of frame 41. Adjustable leg screw 48 connects leg 47 in a similar manner as screwlock 44 connects height adjustable legs 43 to frame 41. As discussed with respect to FIG. 7, when a user desires to lay frame 41 at an oblique or flatter angle, the user may adjust leg 47 by loosening adjustable leg screw 48 so as to place leg 47 at a suitable angle relative to frame 41 so as to provide added support to frame 41. Once leg 47 is placed at an angle desired relative to frame 41, a user may lock leg 47 into place by tightening adjustable leg screw 48. When a user desires to operate system 10 with slide holder assembly substantially upright (as shown for example in FIG. 6), a user may adjust leg 47 to be parallel to the angle of frame 41 by loosening adjustable leg screw 48 and moving leg 47 to the desired angle, and then tightening adjustable leg screw 48 accordingly. Those of ordinary skill will appreciate that there are many ways to provide an adjustable leg screw 48 and the invention is not limited by this feature.

Referring to FIG. 4, crossbar support 472, with joints 474, 475, and 476, may also be provided to connect leg 47 to wall panel 494. Crossbar support is, in one embodiment, a conventional V-shaped joint which, when fully extended (as shown for example in FIG. 7) may provide additional support for frame 41 and rigidity to the positioning of leg 47. In this manner, crossbar 472 may provide additional stability to slide holder assembly 40. In another embodiment, crossbar 472 is not provided. In another embodiment, two legs 47 are provided, one on each side of frame 41. In one embodiment, leg 47 is formed of wood, crossbar 472 is formed of brass, and adjustable leg screw 48 is formed of steel.

Referring to FIG. 4, slot dividers 49a, 49b, and 49c are shown dividing the interior of frame 41 into a plurality of slots. As discussed with respect to FIGS. 6 and 7, a user may insert slides or other desired transparencies into the slots formed by slot dividers 49a, 49b, and 49c. In the embodiment shown, three slots are provided parallel to the longer axis of frame 41. The invention is not limited by the number of slots provided, which may be any number from 1 to as high as desired. For simplicity and ease of reference, FIG. 4 shows three slots, but those of ordinary skill will understand that the arrangement of slot dividers 49a, 49b, and 49c can be readily adapted to any desired number of slot(s) for slide holder assembly 40.

Referring to FIG. 4A, a perspective view of slide holder assembly 40 is shown. In FIG. 4A, frame 41 comprises wall panel 494, frame front panel 491, frame back panel 49a, slot dividers 49b and 49c, and viewing area 42. Frame back panel 49a is essentially identical to frame front panel 41 but mounted on the back or rear side of frame 41. Viewing area 42 is a cutout portion or rectangular hole formed in the middle of each of frame front panel 41, frame back panel 49a, slot dividers 49b and 49c. In one embodiment, the cutout for viewing area 42 is of identical dimensions on each of these panels or slots of frame 41, and each cutout is co-axial with the others. In this way a lumen is formed through frame 41, where said lumen comprises viewing area 42.

As discussed with respect to FIGS. 6 and 7 below, slides 50 may be placed within the slots of frame 41 and illumination source assembly 30 may be directed at the viewing area 42 of frame 41, thus allowing images on the slides 50 to be projected or illuminated.

Referring to FIG. 4B, an exploded perspective view of slide holder assembly 40 and in particular frame 41 is shown. While an exploded view is shown for understanding of the structure of frame 41, those of ordinary skill will understand that the sub-components of frame 41 may be connected to each other in sub-assemblies which need not be identical to the sub-assemblies shown in FIG. 4B.

Referring to FIG. 4B, frame 41 includes frame front panel 49d. Front panel 49d includes front frame 491d, which in one embodiment is formed of wood. Front panel 49d also includes front cutout 492c, which is essentially a lumen formed in front panel 49d and surrounded by front frame 491d.

Referring to FIG. 4B, frame 41 includes frame back panel 49a. Frame back panel 49a includes back frame 491a, which in one embodiment is formed of wood. Back panel 49a also includes rear cutout 492a, which is essentially a lumen formed in back panel 49a and surrounded by back frame 491a.

Frame back panel 49a is connected to wall section 494a, which is orthogonal to the plane of back frame 491a. Wall section 494a is, in one embodiment, formed of wood and is fixedly attached to frame back panel 49a by conventional means (including nail, screw, glue, biscuit, dowel, or interlocking joint). Wall section 494a forms part of frame side wall panel 494, shown in FIG. 4A.

As shown in FIG. 4B, there are two wall sections 494a connected to back frame 491a, one on each side of frame back panel 49a.

Frame back panel 49a is also connected to slot floor section 496a. Slot floor section 496a is orthogonal to frame back panel 491a and wall section 494a. In one embodiment, slot floor section 496a is formed of wood, and is also connected to back frame 491a and wall section 494a by conventional means (including nail, screw, glue, biscuit, dowel, or interlocking joint). Slot floor sections 496a is, in one embodiment, approximately 1 inch square. Slot floor section 496a does not traverse the entire width of the longer axis of back frame panel 491a. Instead, slot floor section 496a only provides a floor or bottom for a portion of frame 41 corresponding to the bottom side of a slot. There are two slot floor sections 496a, one on each side of back frame 491a. By this arrangement, an open space is formed between floor sections 496a, allowing a user to access the slot from the underside of frame 41 if desired.

As discussed with respect to FIGS. 6 and 7 below, slot floor section 496a provides a support or floor on which slides 50 sit when inserted into a slot in frame 41, thus preventing slides 50 from passing all the way through frame 41.

Slot dividers 49b, and 49c are essentially identical sub-assemblies to back frame panel 49a, as shown in the exploded view of FIG. 4B. Thus, slot divider 49b includes slot frame 491b, which surrounds cutout 492b. Slot divider 49b also includes two wall sections 494b, connected one on each side of slot frame 491b, as well as two slot floor sections 496b, also each connected on each side of slot frame 491b. Similarly, slot divider 49c includes slot frame 491c, which surrounds cutout 492c. Slot divider 49c also includes two wall sections 494c, connected one on each side of slot frame 491c, as well as two slot floor sections 496c, also each connected on each side of slot frame 491c.

As shown in FIG. 4A, the sub-assemblies of frame 41 shown in exploded view in FIG. 4B are connected to each other by conventional means. In this assembled configuration, the wall sections 494a, 494b, and 494c in FIG. 4B are configured to form the entirety of wall panel 494 of FIG. 4A. In this configuration, cutouts 492a, 492b, 492c, and 492d form viewing area 42. Viewing area 42 thus, in this embodiment, is formed of the lumen formed by cutout 492a in back frame panel 49a, cutout 492b in slot divider 49b, cutout 493c in slot divider 49c, and cutout 492d in frame front plate 491. In the assembled configuration, floor sections 496a, 496b, and 496c form supporting strips or side flooring along the sides of the bottom of frame 41.

As shown in FIG. 4A, slots are formed by the configuration of the sub-assemblies described with respect to FIG. 4B. Thus, a slot between back frame 49a and 49b is formed on one side by frame back plate 491a, on the other side by slot divider frame 491b, on the lateral sides by wall panels 494a, and on a portion of the bottom by slot floors 496a. As discussed with respect to FIG. 6 below, a slide 50 is adapted to be inserted into such a slot from above, and a user may insert smaller slides into this slot through the aperture in the bottom of the slot between floor sections 496a.

Similarly, a second slot is formed on one side by slot divider frame 491b, on the opposite side by slot divider frame 491c, on the lateral sides by wall panels 494b, and on part of the bottom by slot floors 496b. As discussed above, a slide 50 is insertable into such a slot from above, and a user may access said slot from below.

Similarly, in this embodiment, a third slot is formed on one side by slot divider frame 491c, on the opposite side by frame front plate 491d, on the lateral sides by wall panels 494c, and on parts of the bottom by slot floors 496c. A slide 50 is insertable into such a slot from above, and a smaller slide 50 is insertable into such a slot from below.

Those of ordinary skill will appreciate that the number of slots provided for in frame 41 is not a limitation of the invention, and that any desired number of slot dividers 49b and 49c may be provided as desired for a particular embodiment. In some embodiments, only one slot may be provided, in which case there would be no slot dividers 49b or 49c.

As discussed above, slide holder assembly 40 is configured to hold slides 50, where each slide 50 may portray images or text. A slide 50 includes a transparent or translucent area on which color or black and white images may be placed. Images for slide 50 may be created using translucent inks, paints, tints, watercolors, printing processes, photocopying, or any other conventional method to impress an image or text onto a substrate. A slide 50 may be formed, in one embodiment, of transparent plastic surrounded by a matte or frame of cardboard. A slide 50 should be formed to conform to the dimensions of viewing area 42, although smaller slides 50 are also typically used. Slides 50 may also be tinted, opaque, or textured as desired.

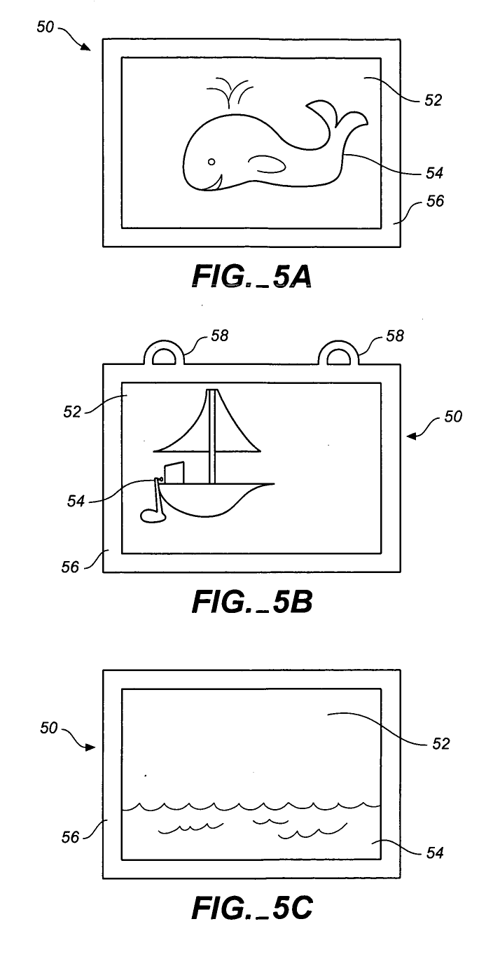

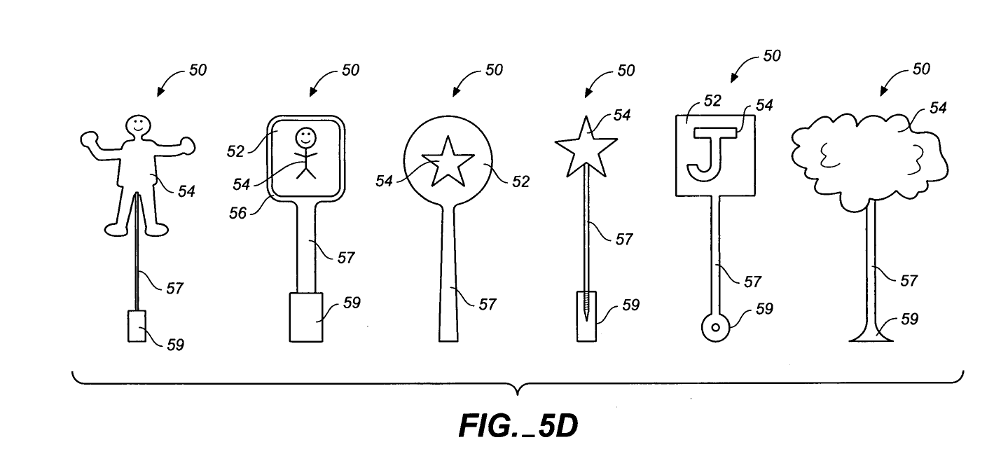

Referring to FIG. 5 various embodiments (shown in FIGS. 5A through 5D) of slides 50 are shown. The examples shown in FIGS. 5A to 5D are exemplary only, and those of ordinary skill will understand that the invention is not limited by the type of image on a slide 50, the exact dimensions of a slide 50, the type of material used to form slide 50, the number of images or amount of text on slide 50, the type of border or handle provided for slide 50, or the number of slides 50 provided with system 10 (which may be none, one, or many). Also, those of ordinary skill will appreciate that slides 50 may be provided which are either entirely blank or have blank areas, where a user may interact with such slide by adding further images, text, color, tints, lines, or other markings to said slide 50 either before or after said slide 50 is inserted into slide holder assembly 40.

Referring to FIG. 5A, an exemplary slide 50 is shown. Slide 50 includes transparent viewing surface 52, which may be formed of plastic, glass, resin, or other composite. Slide 50 includes an exemplary image 54 drawn on or printed into transparent viewing surface 52. Viewing surface 52 may be flexible, so as to allow a user to interact with the image 54 on slide 50 by bending or manipulating the transparent viewing surface material to give the impression that the image 54 may be moving. In this embodiment, slide 50 may be manipulated by a user to cause transparent viewing surface to ripple or bend in such a manner as to cause image 54 to appear to be that of a whale swimming. Slide 50 may also include a border 56 which is connected to or integral with transparent viewing surface 52, surrounds at least a portion of transparent viewing surface 52, and provides rigidity and a surface for a user to more readily manipulate slide 50.

In one embodiment, border 56 may comprise rigid plastic, where the plastic material of border 56 has more rigidity than the material which forms transparent viewing surface 52.

Referring to FIG. 5B, a slide 50 includes a transparent viewing surface 52, an image 54 impressed or otherwise marked on viewing surface 52, a border 56, and handle 58. Handle 58 may be formed of plastic or cardboard, or any other suitable material. Handle 58 provides structure for a user to more readily grasp slide 50 and insert and remove slide 50 from a slot in slide holder assembly 40. Handle 58 is fixedly or removably attached to slide 50, and any desired number of handle 58 may be provided (from zero up to any desired number). Slide 50 may alternatively have handle 58 provided on the bottom edge of slide 50, or if slide 50 is narrower than the width of a slot in slide holder assembly 40 then one or more handle 58 may be provided on either or both sides of slide 50.

Referring to FIG. 5C, a slide 50 is shown. Slide 50 comprises a transparent viewing surface 52, an image on viewing surface 54, and a matte border 56. In this embodiment, matte border 56 comprises cardboard, cardstock, paperboard, paper, wood, plastic, or any hard and rigid material. In this embodiment, matte border 56 may be glued onto both sides of transparent viewing area 52 so as to sandwich the material of transparent viewing area 52 between the portions of matte border 56. Image 54 shown in the embodiment of FIG. 5C is a background image 50 of a seascape. Those of ordinary skill will understand that various types of images 54 may be depicted on a slide 50, including but not limited to characters, landscapes, horizons, planets, stars, oceans, space systems, backgrounds, foregrounds, structures, mechanical or electronic devices, sky, clouds, rain, other weather patterns, rainbows, cartoon characters, depictions from children's fiction, or text (including text alone or text plus images designed to teach a child the alphabet, how to read, vocabulary building, mathematics, numbers, counting skills, geometric shape recognition, color recognition, social skills, artistic skills, language skills, visual skills, coordination skills, or other mental or physical development skills).

Referring to FIG. 5D, various embodiments of slides 50 are shown, where the slides 50 depicted are smaller than the dimensions of a slot provided in slide holder assembly 40. In this embodiment, slide 50 include a transparent viewing surface 52, image 54 impressed on viewing surface 52, and a handle 57. Handle 57 is formed of transparent, rigid material and may be either connected to or integral with transparent viewing surface 52. In alternate embodiments, handle 57 may have a grip 59 at its terminal end to allow a user to more readily manipulate or interact with slide 50. Grip 59 may be glued, screwed onto, or formed integrally onto handle 57. Grip 59 may be plastic, wood, resin, metal, cloth, rubber, or any desired material.

In alternate embodiments, as shown in FIG. 5D, the head of a slide 50 may be shaped, cut out, carved, or otherwise formed to conform exactly to the outline of image 54, resulting in an absence of transparent viewing surface 52. In these embodiments, the cut out image for slide 50 may be any desired image including letters, numbers, geometric shapes, characters, devices, or any appropriate image.

As discussed below with respect to FIG. 6, a user may interact with images 54 by inserting slides 50 such as those shown in FIG. 5D into the bottom apertures of slots formed in slide holder assembly 40, preferably in conjunction with slides 50 (such as those shown in FIGS. 5A to 5C) inserted into slots formed in slide holder assembly 40.

Referring to FIG. 5, those of ordinary skill will understand that slide 50 may be advantageously varied in size, dimension, shape, color, image, text, handle, border, rigidity, movability, and number, all without departing from the scope of the invention.

Referring to FIG. 6, operation of an exemplary illuminated interactive system 10 is shown. In operation, a user would place system 10 in the open position by undoing latch 16, separating casings 12 and 14 from each other via hinge 18, and laying casings 12 and 14 on a desired surface, preferably flat. A user would then manipulate illumination assembly 30 to be at a desired height and facing in a desired direction, preferably towards slide holder assembly 40. A user would preselect any number of slides 50 to insert into the top slots formed in slide holder assembly 40. For example, and without intending limitation, a user could insert slides 50 such as slides 50 shown in FIGS. 5A and 5C into slots formed in frame 41 of slide holder assembly 40, thereby providing an image of a whale overlapping an image of the ocean. A user could manipulate slide holder assembly 40 to be at a desired height and angle, via lockscrews 44, adjustable legs 43, and pivot base hinges 46. A user could then manipulate control circuitry 37 to the “on” position, causing illumination assembly 30 to produce light. Illumination from illumination assembly 30 would then strike images 54 on slides 50, through viewing area 42 in frame 41 of slide holder assembly 40. The illumination from illumination assembly 30 would cause projected images 60 to then be shown on a target surface 62, such as a screen or wall (preferably blank). Illumination from illumination assembly 30 would travel along light path 64 to illuminate the images 54 as desired. A user could exchange slides 50 to alter the image 54 being shown as projected image 60. A user could insert slides 50 such as those depicted in FIG. 5D into the slots formed at the top of frame 41 of slide holder assembly 40. Alternately, a user could insert slides such as those shown in FIG. 5D in the bottom apertures of the slots formed in frame 41 of slide holder assembly 40. By manipulating these slides 50 (which are of the kind shown in FIG. 5D), a user could interact with the images 54, causing images 54 on these slides 50 (which are of the kind shown in FIG. 5D) to become movable or manipulable projected images 60 on target surface 62. In this way, a user could interact with images 54 being projected as projected images 60 by, for example, depicting a work of fiction, reenacting an historical event, performing a theatrical work, recreating a puppet or shadow play show, entertaining a viewer, educating an audience, imparting information, amusing the user (in particular if the user is a child), or otherwise advantageously manipulating images using system 10.

Referring to FIG. 7, operation of another aspect of an exemplary illuminated interactive system 10 is shown. In operation, a user would place system 10 in the open position by undoing latch 16, separating casings 12 and 14 from each other via hinge 18, and laying casings 12 and 14 on a desired surface, preferably flat. A user will then manipulate slide holder assembly 40 so that leg 47 is deployed to support frame 41 such that leg 47 rests on the interior surface of casing 14. A user will, by manipulating leg adjusting screw 48, loosen support leg 47 to allow leg 47 to be positioned at a desired angle, allow crossbar 472 to be extended horizontally, and causing frame 41 of slide holder assembly 40 to be at an oblique angle. A user will also adjust base hinge 46. A user could, if desired, adjust the height of frame 41 by manipulating lockscrews 44 and adjustable legs 43.

A user would then manipulate illumination assembly 30 to be at a desired height and facing in a desired direction, preferably slightly underneath and towards slide holder assembly 40. A user would, in this operational embodiment, insert an acrylic slide 50, which may be opaque, transparent, translucent, or non-light transmitting. A user will then preselect any number of slides 50 to insert into the top slots formed in slide holder assembly 40. For example, and without intending limitation, a user could insert slides 50 which have no images 54 on them or have blank areas on transparent surface 52 into slots formed in frame 41 of slide holder assembly 40. A user could then manipulate control circuitry 37 of illumination assembly 30 to the “on” position, causing illumination assembly 30 to produce light. Illumination from illumination assembly 30 would then strike slides 50, through viewing area 42 in frame 41 of slide holder assembly 40. Preferably, in this operational embodiment, one of the slides 50 inserted into frame 41 will be sufficiently opaque as to allow a user to directly view the images through viewing area 42 without discomfort. In this embodiment then, the illumination from illumination assembly 30 would not necessarily cause projected images 60 to then be shown on a target surface 62. In this operational embodiment, a user could then interact directly with the images 54 illuminated by illumination assembly 30, by for example drawing on transparent surface 52, coloring or painting a slide 50, or otherwise adding markings to a slide 50. In this method, the images 54 from slides 50 will be rendered brighter or more vivid with additional illumination from illumination assembly 30. Illumination from illumination assembly 30 would travel along light path 64 to illuminate the images 54 as desired. A user could exchange slides 50 to alter the image 54 being interacted with or drawn on. Additionally, a user could insert slides 50 such as those depicted in FIG. 5D into the slots formed at the top of frame 41 of slide holder assembly 40. Alternately, a user could insert slides such as those shown in FIG. 5D in the bottom apertures of the slots formed in frame 41 of slide holder assembly 40. By manipulating these slides 50 (which are of the kind shown in FIG. 5D), a user could interact with the images 54, causing images 54 on these slides 50 (which are of the kind shown in FIG. 5D) to become movable or manipulable illuminated images 54. In this way, a user could interact with images 54 by, for example, adding to their color or form, drawing on them, adding to them, interacting with them with movable slides 50 such as shown in FIG. 5D, recreating a puppet or shadow play show, entertaining a viewer, imparting information, amusing the user (in particular if the user is a child), or otherwise advantageously interacting with images using system 10.

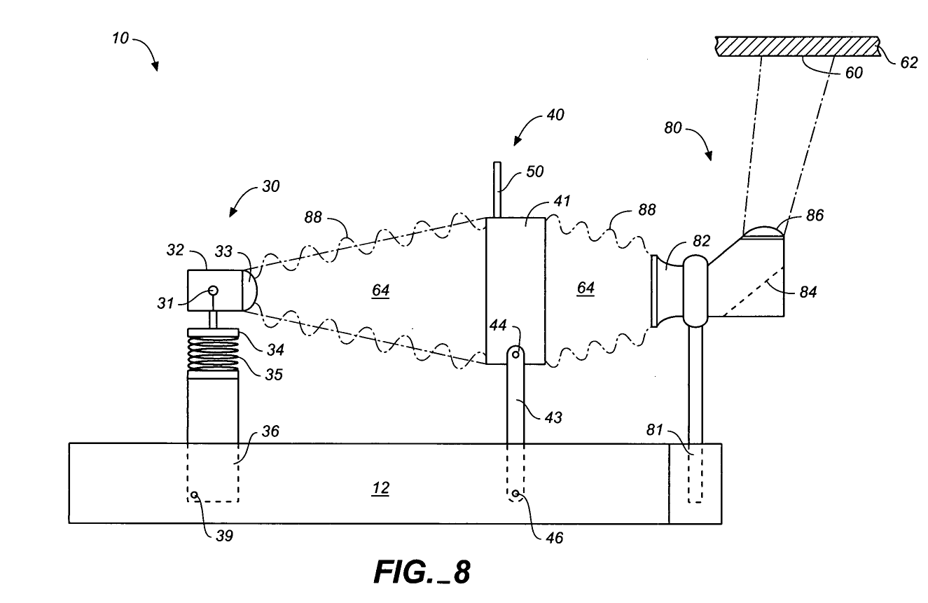

Referring to FIG. 8, an alternate embodiment of illuminated interactive image system 10 is depicted. In this embodiment, there is provided in casing 14 a focal assembly 80. Focal assembly 80 is rotatably connected to the interior surface of casing 14 in a manner similar to the connection of illumination assembly 30 to the interior of casing 12. Alternatively, focal assembly 80 may be selectively inserted or removed from a retaining slot formed in the internal surface of casing 14.

Focal assembly 80 includes a lens 82 which receives images 54 transmitted from slide holder assembly 40 by operation of illumination assembly 30 providing illumination to slides 50 in slide holder assembly 40, as described above. Lens 82 provides user-adjustable focusing lens to allow a user to more readily focus projected images 60. In an alternate embodiment, in addition to lens 82, focal assembly 80 includes a directional mirror 84 and projecting lens assembly 86. In this embodiment, images captured by lens 82 are optically transmitted to mirror 84 which, in turn, transmits the images 54 to projecting lens 86. Mirror 82 and projecting lens assembly 86 are rotatably connected to lens 82, preferably by a ball and socket joint, thus allowing a user to manipulate mirror 84 and lens assembly 86 to project projected images 60 in a desired direction with three degrees of freedom. In this way, a user may optionally project projected images 60 at an angle, on a ceiling, or with additional focusing control. Lens assembly 86 may include additional user-controllable focus controls.

In another embodiment, removable projection housing 88 may be connected between illumination assembly 30 and slide holder assembly 40 as well as between slide holder assembly 40 and lens assembly 80. Removable projection housing 88 is formed of cardboard, paper, cardstock, paperboard, plastic or other lightweight material which is non-light transmitting. Removable projection housing 88 provides further user control over illumination and focusing, by concentrating illumination from illumination source assembly 30 to the path towards slide holder assembly 40 and thence to lens assembly 80. Removable projection housing 88 may be formed in accordion folds, to allow removable projection housing 88 to be stored within casings 12 and 14 when system 10 is in the closed position.

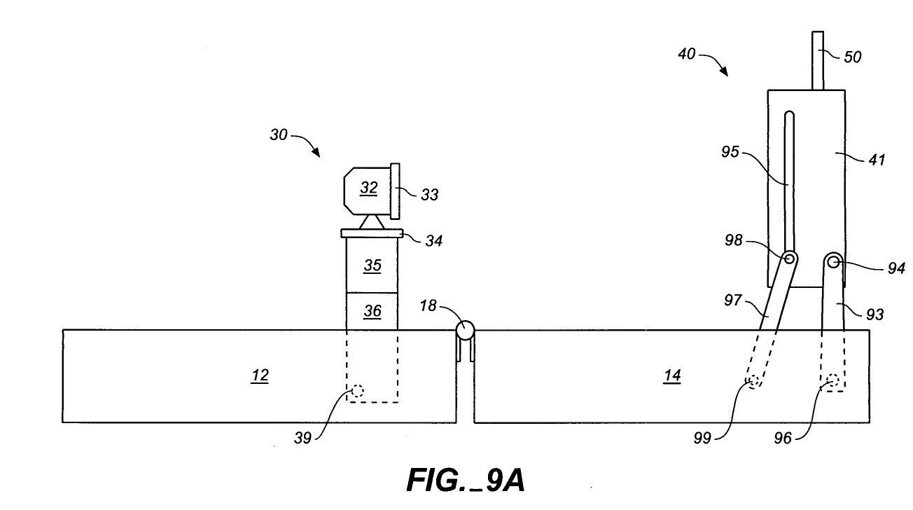

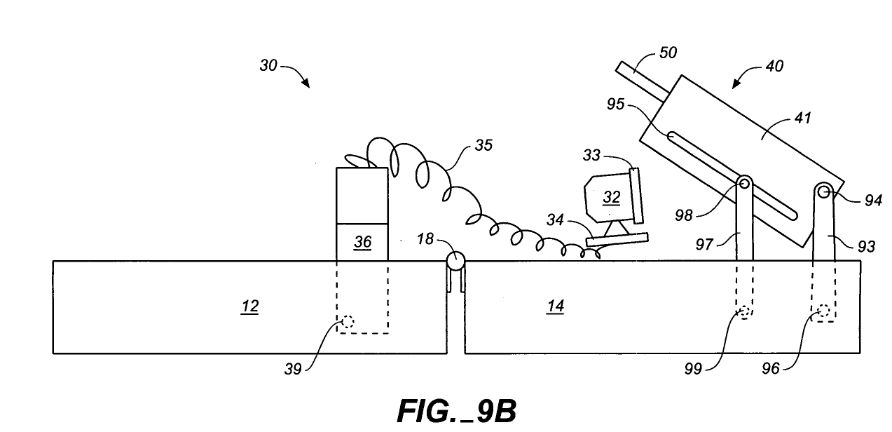

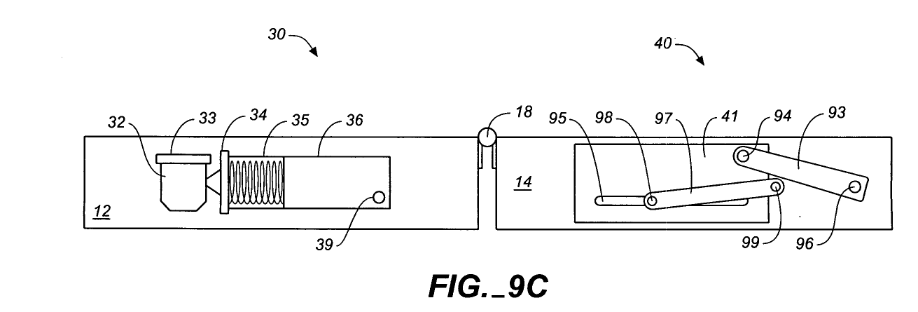

Referring to FIGS. 9A to 9C, an alternate embodiment of illuminated interactive image system 10 is shown. In these figures, light source assembly 30 includes lightbulb casing (or housing or head) 32, lens 33, support 34, height adjusting section 35, base 36, and pivot screw 39. These sub-assemblies of illumination source assembly 30 may be any of the embodiments discussed above. In FIGS. 9A to 9C, slide 50 may also be any of the embodiments discussed above.

In FIGS. 9A to 9C, slide holder assembly 40 includes a side slot 95. Pivot leg 98 is rotatably connected to frame 41 of slot assembly 40. Adjustable screw 98 rotatably connects the top of pivot leg 97 to frame 41 by passing the shaft of screw 98 through pivot leg 97 and into slot 95 and then into a receiving nut (not shown). Pivot leg 97 is also rotatably connected to the interior surface of casing 14 by base pivot 99.

In FIGS. 9A to 9C, support leg 93 is rotatably connected to frame 41 by screw 94. Support leg 93 is also rotatably connected to the interior surface of casing 14 by base screw 96.

Referring to FIG. 9A, when a user desires to operate system 10 to illuminate images from a slide 50, a user may adjust adjustable screw 98 to cause pivot leg 97 to be connected to frame 41 near or at the bottom portion of slot 95. Tightening of adjustable screw 98 causes frame 41 to remain at a desired vertical orientation. A user may then interact with images on a slide 50 illuminated by light source assembly 30.

Referring to FIG. 9B, when a user desires to operate system 10 to illuminate images from a slide 50 and allow a user to interact with a slide 50 by, for example, drawing or writing on a slide 50, a user may adjust screw 98 to allow pivot leg 97 to travel along slot 95 until pivot leg 97 is at a desired position such that frame 41 is at a desired angle relative to the user. Tightening of screw 98 when pivot leg 97 is substantially vertical or when frame 41 is at a desired angle causes frame 41 to remain substantially locked in the desired position and angle. A user may adjust height adjusting portion 35 of light source assembly 30 to more closely align light source assembly 30 with the rear portion of frame 41. Referring to FIG. 9B, height adjusting portion 35 may be a wire spring, a snakelite, a rigid sheathed cable, or any appropriate structure allowing movement and relative stationary placement of housing 32 at a desired height and location.

Referring to FIG. 9C, a user desiring to prepare to place system 10 in the closed position (as shown in FIG. 1), may desire to adjust light source assembly 30 so that it resides within casing 12, and may desire to arrange slot holder assembly 40 so that it resides within casing 14. Referring to FIG. 9C, a user may tilt or pivot light source assembly around base pivot screw 39, so as to cause light source assembly to lay substantially flat within the interior of casing 12.

Referring to FIG. 9C, a user may adjust crew 98 to allow pivot leg 97 to travel at or near the top of slot 95, and lay frame 41 substantially flat within casing 14. Tightening of screw 98 causes frame 41 to stay substantially flat within casing 14. After this operation, those of ordinary skill will understand that system 10 may be placed in the closed position by closing casing 12 by virtue of hinge 18 so that casing 12 rests on casing 14 and thus forms a clamshell or closed structure, such as shown in FIG. 1. Those of ordinary skill will appreciate that slides 50 may also be stored within casing 12 or casing 14, and that other desired apparatus may be stored within available space within casing 12 or casing 14, including pens, crayons, spare parts, tools, batteries, LEDs, lightbulbs, or any other desired device.

### Other Embodiments

While several aspects of embodiments of the invention have been described with regard to various specific embodiments, those of skill in the art will recognize that changes can be made in form, detail, and manufacturing parameters without departing from the spirit and scope of the invention as claimed in the appended claims.

In one embodiment, the approximate dimensions of some of the components of an illuminated interactive system 10 may be approximately as follows:

| COMPONENT | DIMENSIONS (in inches, ±1) |
|---|---|
| Casings 12 and 14 | 12 × 15 × 2 |
| Frame 41 | 10 × 14 × 3 |
| Slide 50 | 9.5 × 13.5 |
| Illumination | Minimum Height: 5 |
| assembly 30 | Maximum Height: 10 |
| | Maximum Diameter of Base 36: 2 |
| | Maximum Diameter of Housing 32: 2 |
| Slide 50 (as shown | Length: 12 |
| in FIG. 5D) | Width: 3 |
| Leg 47 | Length: 8 |
| Adjustable leg 43 | Length: 6 |
| Viewing area 42 | 8 × 12 |
| System 10 in the | 12 × 15 × 4 |
| closed position | |

Those of ordinary skill will appreciate that the various components and sub-assemblies described with respect to alternate or specific embodiments may be rearranged or combined with each other without departing from the scope of the invention as claimed in the appended claims. For example, illumination assembly 30 may be connected to the interior surface of casing 14; casings 12 and 14 may be combined into one platform casing without hinge 18 (in which embodiment this platform casing will not fold or bend, and in order for system 10 to be put in the closed position, an additional cover or lid is provided; in alternate embodiment, no such lid is provided and system 10 is always in the open position); leg 47 and adjustable leg 43 may be rotatably connected to wall panel 494 by the same adjustable screw, as opposed to each having a separate locking screw 48 and 44; and slot floors 496a, 496b, and 496c may be formed as small lips extending from wall panels 494a, 494b, and 494c respectively.

Other alternate embodiments include adding a light source inside frame 41 to provide backlighting effect to the images 54 on slides 50.

In another embodiment, lens 33 may be incorporated into the structure of light bulb 31, particularly in those embodiments where light bulb 31 is an LED.

In another embodiment, there may be a one or a plurality of slides 50 fixedly mounted into frame 41, such that these slides 50 are not removable. In this embodiment, none, some or all of these plurality of slides 50 may have images 54 on them. These slides 50 may be rigid acrylic, hard clear plastic, glass, or any desired resin, composite, or material.

In other embodiments, various components and sub-assemblies of system 10 may each be formed of other appropriate rigid materials or composite materials, such as metal, metallic alloys, hand-carved wood, particle board, resins, thermoplastics, glass, crystal, rubber, or any combination thereof. In other embodiments, various components and sub-assemblies of system 10 may be padded, covered with cloth, covered with leather, colored, painted, decorated, or embellished to coordinate with a desired educational, artistic, or entertainment use of system 10.

In another embodiment, a friction pad, rubber stopper, plastic cap, coating, or other friction device or additive may be connected to or mounted on or placed on the bottom of leg 47, so as to create friction between leg 47 and the interior surface of casing 14.

In other embodiments, slides 50 may each be formed of other appropriate transparent or translucent materials or composite materials, such as glass, crystal, resins, different plastics, paper, fiberboard, cardboard, cloth, or any combination thereof. In other embodiments, slides 50 may be shaped or cut-out to conform to the outline of a desired image, such as picture of a child or a toy. In other embodiments, slides 50 may have any combination of text and images desired.

In other embodiments, interaction devices may be connected by string or wire to casing 14. These interaction devices are devices to allow a user to interact with slides 50. For example, interaction devices 50 may comprise other appropriate devices for imparting markings to slides 50, such as paintbrushes, pens, pencils, wax pencils, paintpens, fingerpaints, markers, watercolors, highlighters, indelible ink markers, magic markers, permanent markers, etchers, clay, wax, ballpoint pens, spray paint, crayons, or any combination thereof.

Persons of ordinary skill will appreciate that changes can be made to dimensions, sizing, relative dimensions, materials, spatial and angular relationships of and between components and sub-assemblies, and other manufacturing processes and other commercial or industrial techniques, all without departing from the scope of the invention as claimed in the appended claims.

The above detailed descriptions are provided to illustrate various aspects of various embodiments of the present invention and are not intended to be limiting. Numerous modifications and variations within the scope of the present invention are possible and will be appreciated by those of ordinary skill to be within the scope of the invention as claimed in the appended claims. Although various aspects of the invention have been described with reference to particular embodiments, these descriptions are only examples of the invention's applicability and should not be taken as limitations. Various other adaptations and combinations of features of embodiments disclosed are within the scope of the invention as defined by the following claims. Accordingly, although various aspects and embodiments of the present invention and advantages thereof have been described, it will be understood by those of ordinary sill that numerous changes, substitutions, and alterations can be made therein without departing from the spirit and scope of the disclosed invention as claimed in the claims which follow.

1. An illuminated interactive system comprising:
a casing;
an illumination assembly mounted on said casing;
a slide holder assembly mounted on said casing separated from said illumination assembly;
wherein said slide holder comprises a viewing area surrounded by framing material and at least one slots for inserting a slide into said slide holder and supports for holding said slide within said slide holder;
whereby said illumination assembly is adapted to provide light directed towards said viewing area of said slide holder;
whereby an image on said slide inserted into said slot is capable of being illuminated by said light from said illumination assembly.

2. The system of claim 1, wherein
said illumination assembly comprises one or more white light emitting diodes.

3. The system of claim 1, wherein
said images are projected onto a target surface.

4. The system of claim 1, wherein
said illumination assembly is height adjustable.

5. The system of claim 4, wherein
said illumination assembly is rotatably connected to a base platform removable from said casing.

6. The system of claim 1, wherein said slide holder assembly is height adjustable.

7. The system of claim 1, wherein said slide holder assembly is rotatably mounted on said casing.

8. The system of claim 1, wherein said slide holder comprises a plurality of slots.

9. The system of claim 1, wherein said slide holder assembly is rotatably connected to at least one leg and said slide holder assembly is adapted to be configured at an oblique angle to said casing.

10. An image illumination apparatus, comprising:
means for providing illumination;
means for holding at least one transparency slide;
whereby said means for providing illumination is operable to provide illumination for at least one image depicted on said slide.

11. The apparatus of claim 10, further comprising means for adjusting the height of said means for providing illumination.

12. The apparatus of claim 10, further comprising means for adjusting the height of said means for holding at least one transparency slide.

13. The apparatus of claim 12, further comprising means for adjusting the angle of said means for holding at least one transparency slide.

14. The apparatus of claim 10, further comprising means for selectively enclosing said apparatus in a casing.

15. A system for illuminating images comprising:
a casing having an interior surface;
an illumination source assembly rotatably connected to the interior surface of said casing;
a slide holder assembly adapted to be mounted at an oblique angle to said interior surface of said casing;
said slide holder assembly having first and second slots formed therein for holding slides;
a rigid slide adapted to be inserted into said first slot in said slide holder assembly;
a second slide adapted to be interacted with inserted into said second slot of said slide holder assembly;
whereby said illumination source assembly is height adjustable and whereby said illumination source assembly is adapted to provide illumination to said slides.

16. The system of claim 15, wherein
said second slide is adapted to be drawn on by a user.

17. The system of claim 15, further comprising a third slide having a handle and adapted to be inserted into any of said first and second slots.

18. The system of claim 15, wherein said slide holder assembly further comprises a support leg rotatably mounted on said slide holder assembly.

19. The system of claim 15, wherein said slide holder assembly further comprises a front frame, a rear frame, and slot dividers, and wherein a viewing area is formed by cutouts from said front frame, said rear frame, and said slot dividers.

20. A children's interactive image projection system comprising:
a casing having a first half and a second half;
said first and second halves rotatably connected by a hinge and adapted to be locked with a latch;
an illumination source assembly rotatably connected to an interior surface of said first half of said casing;
a slide holder assembly rotatably connected to an interior surface of said second half of said casing;
said illumination source assembly comprising one or more light emitting diodes connected in series with a resistive element and a power source;
said illumination source assembly having a height adjustable spring to adjust the height of said illumination source assembly;
said slide holder comprising a frame having a front panel, a back panel, a right wall, a left wall, a top surface, and a bottom surface;
said front panel having a viewing area cut out of the center of said panel;
said back panel having a viewing area cut out of the center of said back panel;
adjustable height legs rotatably connected to said right and left walls;
said top surface having slots formed therein for inserting slides into said frame;
said bottom surface having a partial floor for supporting said slides and having apertures formed in said bottom surface to allow access to said slots;
slides having images thereof adapted to be inserted into said slots;
wherein said viewing area is orthogonal to the direction of the light emitted by said illumination source assembly;
whereby said illumination source assembly emits light towards said slides, whereby images on said slides are projected on a desired target surface.
